(19) United States
(12) Patent Application Publication
(10) Pub. No.: US 2026/0127499 A1
(43) Pub. Date: May 7, 2026

(54) ADAPTIVE WORKFLOW AUGMENTATION FOR IMPROVED TOOL AWARENESS IN AGENTIC TRAINING

(71) Applicant: NEC Laboratories America, Inc., Princeton, NJ (US)

(72) Inventors: Vijay Kumar Baikampady Gopalkrishna, San Jose, CA (US); Manmohan Chandraker, Santa Clara, CA (US); Fucai Ke, San Jose, CA (US)

(21) Appl. No.: 19/380,428

(22) Filed: Nov. 5, 2025

Related U.S. Application Data
(60) Provisional application No. 63/717,369, filed on Nov. 7, 2024.
(60) Provisional application No. 63/719,815, filed on Nov. 13, 2024.

(51) Int. Cl. G06N 20/00

(52) U.S. Cl. CPC G06N 20/00

(57) ABSTRACT

Systems and methods for optimizing visual reasoning task workflow. The systems and methods include generating an initial workflow trajectory to train a model to perform a task, the initial workflow trajectory being formed from environmental information, a prompt, and visual information and storing sub-workflows that form the initial workflow trajectory, the sub-workflows including actions that are performed by Application Programming Interfaces (APIs). The systems and methods further include refining the initial workflow trajectory to form an augmented workflow by iteratively optimizing the sub-workflows of the initial workflow trajectory, the iteratively optimizing includes comparing the environmental information of the augmented workflow with the environmental information from the initial workflow trajectory and selecting a sub-workflow that better meets a predetermined criteria to perform the task and training the model to perform the task with the augmented workflow.

### RELATED APPLICATION INFORMATION

This application claims priority to U.S. Provisional Patent No. 63/717,369, filed on Nov. 7, 2024, and U.S. Provisional Patent No. 63/719,815, filed on Nov. 13, 2024, incorporated herein by reference in their entirety.

### BACKGROUND

### Technical Field

The present invention relates to computer vision and more particularly an improvement to compositional visual reasoning capabilities in generative artificial intelligence models.

### Description of the Related Art

Artificial intelligence (AI) models can act as planners and reasoners to perform complex tasks. Often these AI models are frozen (e.g., do not have parameters updated after training). As a result of not updating their parameters, frozen AI models cannot train to adapt/optimize sub-workflows, leading to significant inefficiencies such as wasted training data, etc. Additionally, frozen AI models do not understand the capabilities of the perception modules they employ, nor do they learn to generate workflows that utilize compositional approaches. In other words, frozen AI models do not fully grasp the capabilities of the tools they choose for a given workflow. This can result in low success rates and inefficiency in the workflow. Even still, when the workflow is logically coherent, the AI model can still fail due to tool errors (e.g., wrong tools selected, extraneous tools selected, insufficient tool selected, incompatible tools) and inaccuracies in the initial workflow. Moreover, training LLMs using full workflows that are incorrect or redundant can limit performance and inhibit future workflow generation optimization.

### SUMMARY

According to an aspect of the present invention, a method is provided for generating an initial workflow trajectory to train a model to perform a task, the initial workflow trajectory being formed from environmental information, a prompt, and visual information and storing sub-workflows that form the initial workflow trajectory, the sub-workflows including actions that are performed by Application Programming Interfaces (APIs). The method further includes refining the initial workflow trajectory to form an augmented workflow by iteratively optimizing the sub-workflows of the initial workflow trajectory, the iteratively optimizing includes comparing the environmental information of the augmented workflow with the environmental information from the initial workflow trajectory and selecting a sub-workflow that better meets a predetermined criteria to perform the task and training the model to perform the task with the augmented workflow.

According to another aspect of the present invention, a system is provided for a processor and a memory storing computer-readable instructions. The memory, when executed, causes the processor to generate an initial workflow trajectory to train a model to perform a task, the initial workflow trajectory being formed from environmental information, a prompt, and visual information and store sub-workflows that form the initial workflow trajectory, the sub-workflows including actions that are performed by Application Programming Interfaces (APIs). The memory can also cause the processor to refine the initial workflow trajectory to form an augmented workflow by iteratively optimizing the sub-workflows of the initial workflow trajectory, the iteratively optimizing includes comparing the environmental information of the augmented workflow with the environmental information from the initial workflow trajectory and selecting a sub-workflow that better meets a predetermined criteria to perform the task and train the model to perform the task with the augmented workflow.

According to yet another aspect of the present invention, a computer program product comprising a non-transitory computer-readable storage medium containing computer program code, the computer program code when executed by one or more processors causes the one or more processors to perform operations. The computer program code comprising instructions to generate an initial workflow trajectory to train a model to perform a task, the initial workflow trajectory being formed from environmental information, a prompt, and visual information store sub-workflows that form the initial workflow trajectory, the sub-workflows including actions that are performed by Application Programming Interfaces (APIs). The computer program code also includes instructions to refine the initial workflow trajectory to form an augmented workflow by iteratively optimizing the sub-workflows of the initial workflow trajectory, the iteratively optimizing includes comparing the environmental information of the augmented workflow with the environmental information from the initial workflow trajectory and selecting a sub-workflow that better meets a predetermined criteria to perform the task and train the model to perform the task with the augmented workflow.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a schematic diagram illustrating a high-level system for illustrating a system for finetuning a model, in accordance with an embodiment of the present invention;

FIG. 2 is a schematic diagram illustrating a system for randomly masking the workflows for data augmentation, in accordance with an embodiment of the present invention;

FIG. 3 is a block diagram illustrating a system for employing the data augmentation technique in for visual information, in accordance with an embodiment of the present invention;

FIG. 4 is a flow diagram illustrating a method for generating augmented data for a model, in accordance with an embodiment of the present invention; and

FIG. 5 is a block diagram illustrating a system for executing the data augmentation, in accordance with an embodiment of the present invention.

### DETAILED DESCRIPTION OF PREFERRED EMBODIMENTS

Visual Reasoning (VR) is a field in computer vision (CV) that draws logical inferences from visual scenes. Compositional VR is one approach used to complete VR tasks in which tasks are decomposed into smaller, more manageable sub-tasks, which improve efficiency and accuracy. Compositional VR can use Large Language Models (LLMs) or other artificial intelligence (AI) models as planners, action interpreters, and reasoners to generate tool utilization workflows for actions to complete a given task.

These LLMs can develop an understanding of the nuances of the tools they employ and become more adept at using them effectively. In other words, complex tasks can be decomposed into simple plans and then several tools (which correlate to sub-tasks or sub-workflows) can be used to solve these simple sub-tasks instead of overwhelming a single tool with complex plans.

Embodiments of the present invention can include a workflow generation mechanism that can self-correct sub-workflows. The workflow can be a set of actions (e.g., sub-workflows) that are utilized to complete a given task. Self-correcting the sub-workflows can include optimizing the actions reflecting the sub-workflows. The optimizing can include masking, such as, e.g., random masking, of actions.

Embodiments of the present invention include several steps such as data generation and model training. Data generation includes having an LLM generate workflows for new input queries and refine them to improve data generation efficiency. Without this refinement, many generated workflows would be discarded, leading to significant (training) data loss. Model training includes having verified (e.g., correct) workflows used to fine-tune the LLM. During fine-tuning, an action-level masking strategy can be applied, which regularizes training and augments the data, ultimately enhancing model performance.

VR can include constructing a detailed visual scene representation, then applying systematic reasoning to the scene where the systematic reasoning can be akin to human cognition. This process can be guided by textual queries or prompts. Since VR is akin to human cognition, VR can be applied to a variety of tasks. These tasks include Visual Question Answering (VQA), Visual Commonsense Reasoning (VQR), Visual Entailment/Natural Language for Vision (NLVR), Scene Graph Reasoning, Referring Expression Comprehension/Grounding, Visual Dialog, Composition Tasks, Spatial/Temporal Reasoning (Video QA), Counterfactual Visual Reasoning, Visual Analogy and Puzzle Solving, Visual Adversarial Reasoning, and Visual Commonsense Prediction, etc.

LLMs can decompose complex tasks into manageable subtasks and generate corresponding action plans through chain-of-thought (CoT) reasoning abilities. The action plan can include high-level text descriptions outlining the task goal or fine-grained actions in text, symbols, or even computer code (e.g., Python®) for logical operations. LLMs can then execute the subtasks later or call on external tools to perform the subtasks. LLM as reasoners can deduce answers to problems in prompts though logical inference, analogical reasoning, symbolic manipulation, etc.

While embodiments of the present invention include LLMs, the LLMs, e.g., can be multimodal LLMs (MLLMs), Visual Language Models (VLMs), or other generative artificial intelligence models (GenAI models) or analytical AI models.

Embodiments of the present invention include a data augmentation technique to generate numerous trajectories from the target environment using instruction-final answer pairs. The technique employs a current policy to explore the environment and generate trajectories based on the final answer (or action). The trajectories generated through the exploration can be noisy since the agent saves all intermediate sub-goals. To address this noise, the trajectories can be modified using the final answer or action. The new trajectories can then be used to train the agent within the target environment by employing a masking strategy, which forms a sub-goal and has the agent predict the sub-goal.

Noise can come from several sources including data-level noise, process-level noise, model-level noise, and decision-level noise. Data-level noise can include e.g. poor data quality, inconsistent annotations, or extraneous signals. Process-level noise can include, e.g., workflows out of order, race conditions or latency spikes, or logging or monitoring inconsistencies. Model-level noise can include e.g. random initialization dropout. or stochastic gradient updates. Decision-level noise can include e.g. epistemic uncertainty.

Embodiments of the present invention include a peeking-endpoint strategy which allows the LLM to occasionally “peek” at the endpoint (e.g., final state, target, or partial label) during learning/training, at any time, when creating trajectories. This strategy allows the model to prevent model collapse, guides representations in latent spaces, and balances the difficulty of training the model.

The agentic framework can also enable the LLMs to have autonomous capabilities. The framework can enable LLMs to iteratively explore and refine workflows that are both logically coherent and practically viable. These refined workflows can be considered augmented data and can enhance the LLMs agentic qualities. Agentic LLMs can better mitigate errors introduced by external tools and improve their ability to identify effective solutions independently. Also, the agentic framework can identify actions that can be helpful for learning and adopt a training method that focuses on cloning correct behaviors during training.

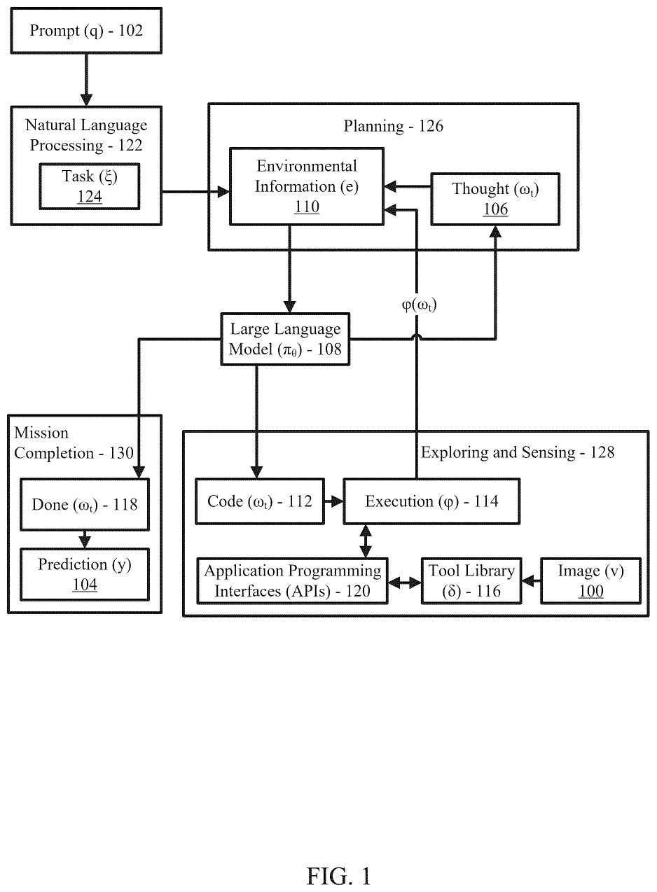

Referring now in detail to the figures in which like numerals represent the same or similar elements, and initially to FIG. 1, a block diagram is shown illustrating an embodiment of the present invention for finetuning an LLM. Embodiments of the present invention can include an instruct-masking training method for more efficiently fine-tuning agentic LLMs. Other embodiments of the present invention can also include an exploration-based workflow generation method that minimizes data waste and is suitable for smaller training datasets.

The exploration-based workflow generation technique, integrated with a multi-turn agentic visual reasoning framework, enables LLMs with autonomous capabilities for better planning 126 and exploring and sensing 128. LLM 108 can detect when the predicted answer is wrong and revise the generated plan to generate a new workflow that leads to the correct outcome. This “exploration” can determine which of multiple valid workflows that reach the same final answer is optimal since tool and environmental factors can cause failure even if the plan is correct. The exploration strategy allows LLM 108 to try alternative workflows when one leads to an incorrect result.

Upon evaluation of LLM 108, one of several actions can occur, including thought 106, code, 112, or done 118. Thought 106 and code 112 result in the framework iteratively performing or evaluating the workflow, respectively, another time, hence being multi-turn. Done 118 results in a workflow that is completed and is not further evaluated for optimization.

This approach also enables a deeper (better) investigation of each environment, allowing the model to autonomously design, adjust, and generate more effective workflows after the initial plan is generated. Through this exploration process, LLM 108 can identify workflows that are logically coherent and practically viable in real-world scenarios.

To clone correct actions and filter incorrect actions within a workflow during training, an instruct masking fine-tuning technique is employed. This leverages the advantage of receiving feedback on each action performance through exploration and can augment the data for workflow generation. Once the workflow generation is complete the workflow can be sent to mission completion 130. The framework can identify incorrect actions using rule-based methods, such as detecting the presence of error messages.

Other embodiments of the present invention can be combined with or used alternatively to cloning and filtering techniques. These can include a framework that can identify incorrect actions using self-consistency checking, a world model/constraint validation, other forms of execution feedback (grounding), critic models/self-critique, consistency with a prior state(s), reward models/Reinforcement Learning (RL), counterfactual reasoning, and self-supervised fine-tuning (SFT).

RL can be used to adjust actions selected based on feedback received throughout the reasoning process, and environmental feedback. These adjustments can optimize the sub-workflows for the given task in the VR.

Consequently, correct actions are identified and randomly masked for more robust training. The random masking can occur in code 112. Code 112 can reflect randomly masked sub-workflows that are executed in execution 114 by comparing the results with Application Programming Interfaces (APIs) 120 from tool library 116.

Other embodiments of the present invention can be configured to include token masking, patch masking, feature masking, etc., instead of random masking.

After the random masking, LLM 108 is instructed to generate the target step by providing a masked workflow, rather than directly generating the next step. This approach selectively skips noisy steps and masks correct actions, instructing LLM 108 to augment on the correct actions (e.g., prioritize relevant information more effectively).

In the workflow generation stage (planning 126), LLM 108 can generate a sequence of actions that are executed within the environment. For example, an action can be “call the object detector to find all persons in the image.” Several types of errors can occur during this process including tool execution error and outcome mismatch. Tool execution error can be if the detector fails or returns an error, the agent (LLM 108) can recognize this and mark the corresponding action as incorrect. Outcome mismatch can be if the workflow executes successfully but the predicted final answer (e.g., 3) differs from the ground-truth outcome (e.g., 4), the agent can again flag the current action as incorrect. Since LLM 108 has access to the ground-truth final outcome, LLM 108 can use this feedback to revise its plan and explore alternative actions or workflows. This evaluation is implemented through a rule-based mechanism that inspects the workflow generated and labels each action as correct or incorrect (noisy). In contrast to methods that use SFT on full, noisy workflows, embodiments of the present invention direct LLM 108 to masked, correct actions thereby reducing the impact of noise through targeted instructing and masking. Additionally, the framework fine-tunes LLM 108 ability to self-correct training on complete workflows with embedded self-correction steps during training process.

In framework a multi-turn agentic model for compositional VR tasks, let v be a visual input (e.g., image 100) and q be a textual query (e.g., prompt 102) related to the visual input. Task 124 can be represented by ξ={(v,q),y} where a visual-textual query pair (v, q) corresponds to the answer y (prediction 104). Task 124 can be determined from applying natural language processing (NLP) 122 to prompt 102. The visual input can be in a form other than image 100 such as, e.g., videos, and prompt 102 can be non-textual inputs, such as e.g., audio, code, etc.

When using the compositional VR, a workflow can be represented by ω={ω_{1:t}}. Each workflow includes each generated suggested action (ωₜ) (e.g., thought 106, code 112, or done 118) from an agentic LLM 108 (π_{θ}). Embodiments of the present invention can have the objective be to optimize the parameters θ of the agentic LLM 108 to accurately provide the correct workflow for mission completion 130.

In other words, agentic LLM 108 receives a query in the form of prompt 102 and image 100 and be trained to devise a set of steps (e.g., workflow to execute the query) most correctly. Agentic LLM 108 can be represented by

$${π}_{θ} ( {ω}_{1} \vert {e}_{0} ) = {\prod }_{t = 1}^{T} {π}_{θ} ( {ω}_{1} \vert {e}_{t - 1} ) , \qquad {e}_{t} = {\sum }_{t = 1}^{T} ϕ ( {ω}_{t} \vert {e}_{t - 1} ) + {e}_{0}$$

where eₜ represents the environment(al) information 110 received after interacting with the environment and applying the action on LLM 108, and φ is an execution function. T represents the final environmental information 110 and t is the environmental information at a given interaction step. Environmental information 110 can also be considered environmental feedback. LLM 108 (e.g., planner/agent) decides when to stop the workflow by returning <Done 118> or a similar (end) token. If the token is returned, then the “index” becomes T, otherwise the index will be intermediate steps t. The outcome after executing the action (tool) becomes the environmental information 110 at these steps.

Execution (φ) 114 represents the function that maps each code 112 taken by LLM 108 to the corresponding feedback received from the environment. Environmental information 110 for each task 124 is given by

$${e}_{0}^{ξ} = \{ ( {v}^{ξ} , {q}^{ξ} ) , {δ}^{ξ} \} ,$$

where δ is defined as tool library 116. Thus, for each task 124, prediction 104 can be

$$\hat{y} := ϕ ( {π}_{θ} , {\sum }_{t = 1}^{T} ϕ ( {ω}_{t} \vert {e}_{t - 1} ) + {e}_{0} ) .$$

The multiturn agentic framework offers the advantage of incorporating aggregated environmental information 110 (eₜ₋₁) to enable incremental reasoning. This information is grounded in the environmental context, enabling LLM 108 to iteratively refine its generation process. Consequently, environmental information 110 from prior explorations provides increasingly precise (e.g., accurate) environmental insights and enhances the capacity of LLM 108 to produce accurate and contextually grounded prediction 104.

The incremental reasoning can systematically remove noise from the actions and improve the training of the model for compositional VR. In each iteration, the positive actions are identified to make the model clone those actions and ignore negative actions. By including a multi-turn agentic LLM 108, negative actions can be discarded and improving the capabilities of agentic LLM 108 to produce better workflows in the future. The “correct steps” in the same sequence are used to generate the correct outcome (e.g., final answer). By remembering (masking and prompting LLM 108 to generate the workflow) the correct steps (e.g., positive actions), LLM 108 can produce better workflows during testing/inference.

Types of generated actions can include, e.g., ωₜ∈{<Code 112>, <Thought 106>, <Done 118>}, corresponding to planning (and reasoning) 126, exploration and sensing 128, and mission completion 130, respectively.

Planning 126 includes having LLM 108 generate step-by-step instruction for next execution or tool call for a given query (e.g., prompt 102). Exploring and sensing 128 includes separate exploring and sensing aspects. The exploring aspect includes providing LLM 108 with access to the “outcome” (e.g., final answer) during data generation. This enables LLM 108 to detect when the predicted answer is wrong and revise the plan to generate a new workflow that leads to the correct outcome. There can be multiple valid workflows that reach the same final answer, but due to tool or environmental errors, some may fail even if the plan is correct. The exploration strategy allows the LLM to try alternative workflows when one leads to an incorrect result. The sensing aspect allows the agent to observe the environmental information 110 (the output after executing any action) and make decisions about the next action. Mission Completion 130 includes having LLM 108 decide when to stop the workflow by emitting <Done 118>.

<Thought 106> enhances the reasoning process by analyzing the provided environmental information 110 to facilitate better next-step exploration. When <Code 112> is generated/determined, agentic LLM 108 initiates exploration (e.g., execution 114 φ(*)), utilizing perception tools to gather additional environmental information 110. The new environmental information 110 is updated, e.g., appended, to the existing environmental information 110 incrementally as eₜ=eₜ₋₁+φ(ωₜ) to support incremental reasoning.

The exploration process is achieved by generating code, e.g., Python®, that can be executed using predefined tools, e.g., APIs 120, which connect to tool library 116 for perception. Once environmental information 110 contains sufficient information and agentic LLM 108 has completed the prediction for q, <Done 118> is generated to conclude task 124, indicating the end of the workflow. Sufficient information can mean the agent determines that the action produced an output that is same as the ground truth (e.g., final outcome), the agent can decide to stop the workflow. Tool library 116 can include the tools that are applied to image 100 such as preprocessing, feature extraction, manipulation/editing, analysis and inference, visualization, etc. Tool library 116 selects APIs 120 to perform the desired tool functions on image 100 in accordance with task 124 from agentic LLM 108.

During the workflow generation phase, prediction 104 for task 124 is provided as prior information to LLM 108, which modifies the policy following

$${π}_{θ} ( {ω}_{t} \vert {e}_{0} , y ) = {\prod }_{t = 1}^{T} {π}_{θ} ( {ω}_{t} \vert {e}_{t - 1} , y ) .$$

A conventional workflow using π_{θ}(ω₁|e₀), which only accepts e₀ as a pre-condition and does not incorporate further environmental information 110. Embodiments of the present invention include additional environmental information 110 (unlike conventional workflows) which is useful in distinguishing between different tools in tool library 116 and validate the workflow, as the workflow can initially appear correct but fail in practice due to tool errors (e.g., tool execution error). Relying on a new generation policy, LLM 108 can collect a dataset of workflow (D_{ω}). The dataset can be used in future workflows as well as the current workflow for task 124.

An objective of embodiments of the present invention is to use the collected dataset to improve agentic LLM 108 by tuning the parameters θ instead of using a binary-valued reward function R:(ω, v, y)→{0, 1}, which disregards the effectiveness of individual actions also used in conventional methods. The effectiveness of an action in a binary reward framework (e.g., a single-turn framework) cannot be evaluated adequately, as there is no intermediate environmental information 110 to guide the process. In other words, in conventional methods the input and the output are considered but not individual steps that form the output. This can lead to failures or inefficiencies in the actions and tools selected that a multi-turn workflow generation can optimize for.

Embodiments of the present invention use an exploration-based workflow generation method which can store intermediate environmental information 110 and evaluate effectiveness of the workflow using a rule-based approach. When eₜ=φ(ωₜ) does not indicate execution 114 errors or suggests rethinking and readjusting the workflow, the action is tagged with κₜ=1 as an effective action, otherwise κₜ=0. In other words, κₜ indicates correct (κₜ=1) and wrong (κₜ=0) actions.

This more granular approach generates workflows that improve the compositional VR by evaluating each action in task 124 individually. Compositional VR which involves multi-modal inferencing using a variety of different tools is further improved since each action within task 124 is trained more intentionally (e.g., individually), which can otherwise be overlooked. Multi-turn interaction allows the action to decompose further if the current action (at time step t) results in a wrong outcome.

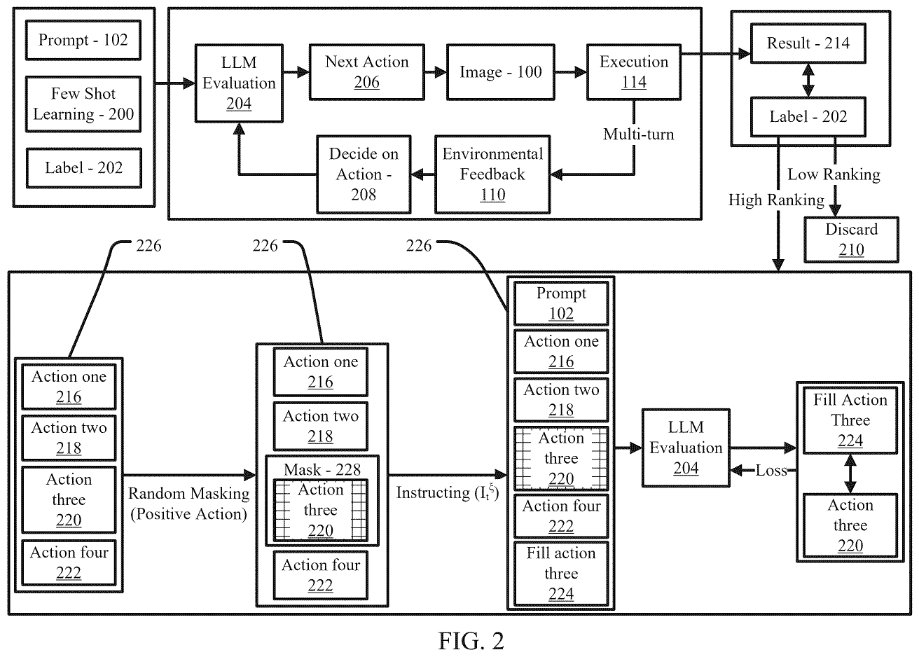

Now referring to FIG. 2, a schematic implementation of the random masking to improve workflow finetuning is illustrated in accordance with an embodiment of the present invention. the finetuning aids LLM 108 (FIG. 1) in generating an optimized workflow. Mask 228

$${m}_{t}^{ξ}$$

can be defined as a context-level mask for an action in task 124. The instruction

$${I}_{t}^{ξ}$$

corresponds to instructing the model to regenerate the masked 228 action instead of proceeding to the next step. Then the action is transitioned into the generated dataset

$${d}_{t}^{ξ} = \{ {ω}_{1 : t}^{ξ} , {m}_{t}^{ξ} , {ω}_{t + 1 : T}^{ξ} , {I}_{t}^{ξ} \}$$

and the new instruct-masking dataset can de denoted by DA and behavioral cloning is applied by minimizing the reward-weighted loss according to

$$J ( θ ) = {𝔼}_{( ω , e )} ∼ {D}_{M} [ R ( ω , e , κ ) {ℒ}_{N L L} ( p , q ; θ ) ] ,$$

where L_{NLL}(p, q; θ) is the negative log-likelihood loss defined by

$${ℒ}_{N L L} ( p , q ; θ ) = - {𝔼}_{( ω , e ) ∼ {D}_{M}} [ {\sum }_{t = 1}^{T} log {π}_{θ} ( {ω}_{t} \vert {d}_{t} , e ) ] .$$

Prompt 102 can be combined with few shot learning 200 and label 202. The combination can be input into a model to generate LLM evaluation 204, which can produce a next action 206 (e.g., thought 106, code 112, done 118). The action can be combined with image 100 and input to execution 114 which can decide what to do next based on result 214. If result 214 is done 118 then label 202 can be evaluated. A high ranking label 202 continues to full workflow 226. A low ranking label 202 is discarded 210 from future use.

Alternatively, if the action from execution 114 is not done 118, then the action can be code 112. Assuming the code does not reach an appropriate result in execution 114, the action can be thought 106. As thought 106 is evaluated, the action can include environment information 110 to decide the next iteration of action 208. From the decision of action 208 the LLM can reevaluate the action in LLM evaluation 204 to iterate (e.g., be multi-turn) through the process again.

Environmental information 110 can be either positive feedback or negative feedback. If environmental information 110 is positive feedback action 208 can be to continue. If environmental information 110 is negative feedback, action 208 can be refine the action.

Referring back to code 112, the masking can include several actions such as action one 216, action two 218, action three 220, and action four 222. In an example embodiment of the present invention, action two 218 can have negative feedback while action one 216, action three 220, and action four 222 can have positive feedback. The random masking can identify which sub-tasks have positive feedback and mask the positive action while avoiding the negative feedback actions (action two 218). In FIG. 2, action three 220 can be masked. After action three 220 is masked, instructing can occur such that there is a prompt 102 and fill action three 224 is formed.

Fill action three 224 can replicate action three 220. With action three 220 replaced by fill action three 224, LLM evaluation 204 can be applied with the randomly masked set of actions. The output of LLM evaluation 204 can be a determination (in the form of a loss) if fill action three 224 improved full workflow 226, kept full workflow 226 than same, or made full workflow 226 worse in comparison to action three 220 with respect to a given predetermined criteria. The replication can occur while optimizing (e.g., minimizing) for the loss within LLM evaluation 204. Fill action three 224 can learn from correct action by instruct-masking. This operation can be performed several times for all correct/positive actions in the workflow, until action two 218 is masked and LLM evaluation identifies a change in loss, indicating that action two 218 was not previously optimized and there is opportunity to optimize this action.

Fill action three 224 can aim to improve full workflow 226 in any number of ways such as improve runtime, improve accuracy, improve computational efficiency, etc. The selection of the predetermined criteria can be selected by a user, individually/manually for a given sub-workflow (e.g., the object detection can have higher accuracy and the object classification can have better computational efficiency), or follow a heuristic for the entire full workflow 226.

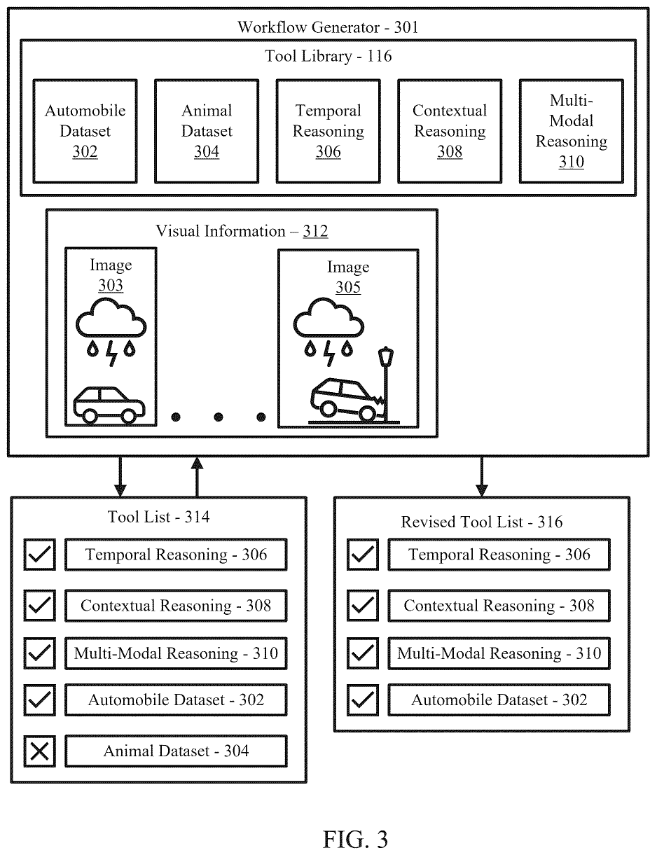

Referring to FIG. 3, a block diagram illustrating a situation that can employ a compositional VR workflow generation is shown, in accordance with an embodiment of the present invention. Workflow generator 301 generates a workflow for compositional VR tasks from visual information 312 and tool library 116. Visual information 312 depicts a video. In the video there is visual data and audio data. Other types of data are also contemplated such as metadata. In visual information 312 there is a vehicle 303 driving in inclement weather. In an embodiment of the present invention, the workflow can be generated and randomly masked to identify tools that are not necessary for the compositional VR. An optimized set of tools from tool library 116 can be selected for a workflow to complete a given task based on the masking and action evaluations.

Vehicle 303 can be driving in a thunderstorm with heavy precipitation. At some point in visual information 312 vehicle 303 can collide with another object, causing an accident 305. Workflow generator 301 can identify what visual information 312 is depicting through a variety of methods including metadata about the weather conditions of the location of the video at the time the video was taken, sounds in the visual information 312 such as e.g., thunder, weather alarm bells, sounds of a screeching tires, and sudden sounds akin to a collision.

The tools in tool library 116 can include automobile dataset 302, animal dataset 304, temporal reasoning 306, contextual reasoning 308, and multi-modal reasoning 310. Workflow generator can initially develop tool list 314 with the relevant tools from tool library 116. At first, all the tools can be included where workflow generator 301 determines that based on visual information 312 a vehicle hit an animal such as a tall animal such as e.g., a giraffe.

After applying embodiments of the present invention, workflow generator 301 can reevaluate visual information 312. Upon this reevaluation, it can be more apparent that vehicle 303 did not crash into an animal, but rather into a streetlight to cause accident 305. Workflow generator 301 can determine a vehicle was in the scene (using automobile dataset 302) but not an animal (using animal dataset 304); and the inclement weather (using contextual reasoning 308), the speed of the vehicle (using temporal reasoning 306) and sounds of the scene (using multi-modal reasoning 310) likely factored into the collision. Workflow generator 301 can form revised tool list 316 from the reevaluation which is correct. With revised tool list 316 the workflow in an AI model can more accurately answer questions about the scene and do so more efficiently. For example, questions like “how fast was the car going?,” “were there any other vehicles in the area?,” and “what did the vehicle collide with?” can be analyzed and answered confidently.

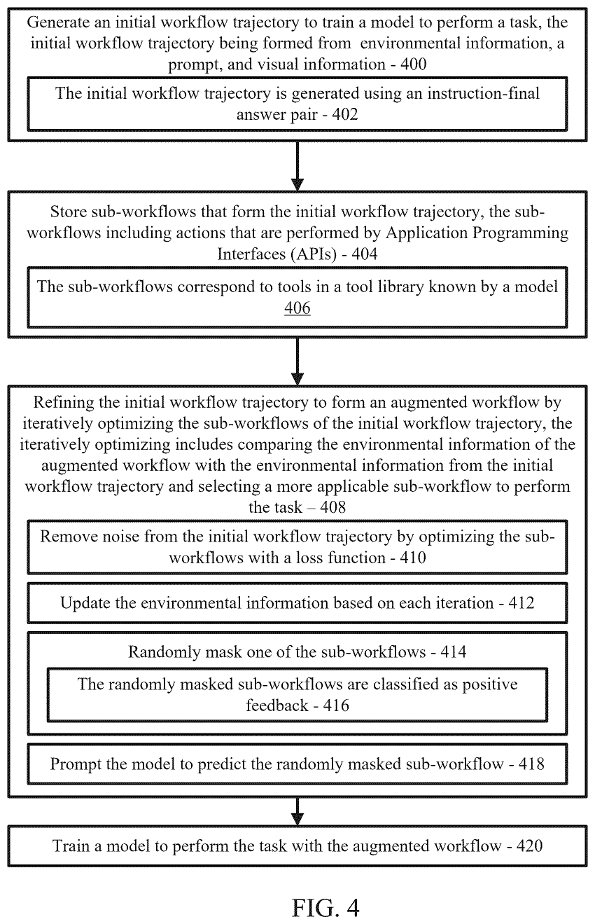

Referring to FIG. 4, a method of generating augmented data for workflows to train a model is illustrated, in accordance with an embodiment of the present invention. In block 400, an initial workflow trajectory can be generated to train a model to perform a task, the initial workflow trajectory being formed from environmental information, a prompt, and visual information. The workflow trajectory can include possible functions performed together to achieve the goal (task) encompassed by the prompt. The environmental information can be spatial information, object-level information, relational information, temporal information, contextual and higher-level information, etc. Spatial information can include object location and coordinates, depth information, spatial relationships, scene layout, etc. Object-level information can include object attributes, semantic segmentation, functional properties, etc. Relational information can include relational triplets, interactions, logical dependencies, etc. Temporal information can include object tracking, causal reasoning, etc. Contextual and higher-level information can include task-oriented information, human intention recognition, uncertainty, etc.

The prompt can be natural language, audio, computer language, zero shot/one shot/few shot, etc. The visual inputs can be images, videos, depth maps, medical images/remote sensing images, microscope/telescope images, etc. Other types of inputs outside visual modalities are also contemplated. For example, audio reasoning, physical sensor data (e.g., inertial measurement unit (IMU) devices), symbolic or structured data (e.g., graph, tabular data), etc.

In block 402, the initial workflow trajectory is generated using an instruction-final answer pair. The instruction can be the task in the prompt. The final answer be can a known ground truth to guide the workflow trajectory training. The final answer can also guide the workflow trajectory tasks to achieve the answer but without an optimized path to achieve the answer, so the model can learn how to achieve the answer without overfitting to a specific solution In other words, the final answer guides the workflow to explore diverse solution paths instead of following a fixed trajectory, reducing the risk of overfitting to one specific solution. Alternatives can instruction-process-answer triplet, input-action-outcome tuples, goal-plan (sub-steps)-execution-result techniques, context-query-response techniques, task-intermediate-feedback-refinement techniques, input-latent representation-output, etc.

In block 404, sub-workflows that form the initial workflow trajectory can be stored, the sub-workflows including actions that are performed by Application Programming Interfaces (APIs). The sub-workflows can be actions that call the APIs, APIs themselves, or some other configuration. In block 406, the sub-workflows correspond to tools in a tool library known by a model. In other words, the sub-workflows can be selected from a list of actions/APIs that the model is already aware of. The stored sub-workflows can each be modified to optimize the model for performing the tasks rather than modifying the entire workflow.

In block 408, the initial workflow trajectory can be refined to form an augmented workflow by iteratively optimizing the sub-workflows of the initial workflow trajectory. The iteratively optimizing includes comparing the environmental information of the augmented workflow with the environmental information from the initial workflow trajectory and selecting a more applicable sub-workflow to perform the task. Selecting a sub-workflow that better meets a predetermined criteria can include modifying a sub-workflow, such as e.g., changing the actions in the sub-workflow, adding one or more sub-workflows, removing one or more sub-workflows, changing the order of sub-workflows, combinations of these modifications, etc. Additionally, or alternatively, selecting the sub-workflow that better meets a predetermined criteria can change parameters, hyperparameters, etc., of a sub-workflow/action/API to better perform the task. The predetermined criteria can be selected manually or follow a heuristic such as, e.g., perform the task fastest, perform the task most accurately, perform the task least computationally expensive, etc. The predetermined criteria can be for the whole task or for each sub-workflow individually.

In block 410, noise is removed from the initial workflow trajectory by optimizing the sub-workflows with a loss function. In block 412, the environmental information is updated based on each iteration.

In block 414, one or more of the sub-workflows are randomly masked to form a randomly masked sub-workflow. In block 416, the randomly masked sub-workflows are classified as positive feedback. In other words, in an embodiment of the present invention, sub-workflows with positive feedback are randomly masked. In another embodiment of the present invention, negative feedback is randomly masked, or a mix of positive and negative feedback can be masked. In block 418, the model is prompted to predict the randomly masked sub-workflow. In block 420, the model is trained to perform the task with the augmented workflow.

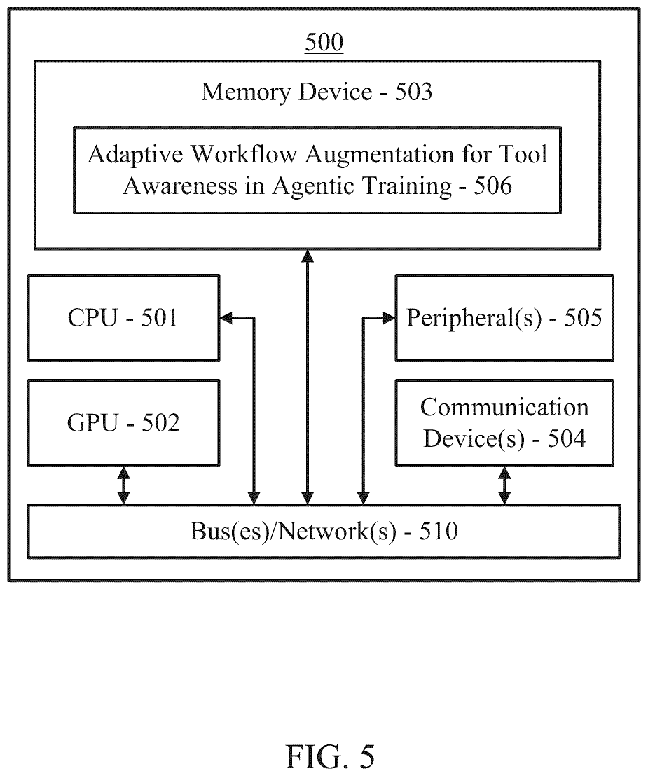

Referring to FIG. 5, a block diagram is shown for an exemplary processing system 500, in accordance with an embodiment of the present invention. Processing system 500 can generate an adaptive workflow augmentation for tool awareness in agentic training. In other words, processing system 500 can generate adaptively create workflows and train a model to generate workflows such that the model is aware of the tools the model is using. This can be so that in future, when assigned a task, the model can select the best tools for the task. The system can train the model to by masking actions corresponding to tool and optimizing based on a loss. Processing system 500 includes a set of processing units (e.g., CPUs) 501, a set of GPUs 502, a set of memory devices 503, a set of communication devices 504, and a set of peripherals 505. CPUs 501 can be single or multi-core CPUs. The GPUs 502 can be single or multi-core GPUs. The one or more memory devices 503 can include caches, RAMs, ROMs, and other memories (flash, optical, magnetic, etc.). The communication devices 504 can include wireless and/or wired communication devices (e.g., network (e.g., Wi-Fi®, etc.) adapters, etc.). The peripherals 505 can include a display device, a user input device, a printer, an imaging device, and so forth. Elements of processing system 500 are connected by one or more buses or networks (collectively denoted by the figure reference numeral 510).

In an embodiment of the present invention, memory devices 503 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 503 store program code or software 506 for an adaptive workflow augmentation for tool awareness in agentic training. The generation and execution software 506 includes generating an initial workflow trajectory to train a model to perform a task, the initial workflow trajectory being formed from environmental information, a prompt, and visual information and storing sub-workflows that form the initial workflow trajectory, the sub-workflows including actions that are performed by Application Programming Interfaces (APIs). Also, software 506 includes refining the initial workflow trajectory to form an augmented workflow by iteratively optimizing the sub-workflows of the initial workflow trajectory, the iteratively optimizing includes comparing the environmental information of the augmented workflow with the environmental information from the initial workflow trajectory and selecting a sub-workflow that better meets a predetermined criteria to perform the task and training the model to perform the task with the augmented workflow. The memory devices 503 can store program code for implementing one or more functions of the systems and methods described herein.

Of course, the processing system 500 may also include other elements (not shown), as readily contemplated by one of skill in the art, as well as omitting certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 500.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed. Embodiments of the present invention can include features depicted and described in alternative embodiments and may be excluded for the sake of brevity and clarity. Lists of embodiments and other explanations of technical details are intended to be non-limiting. While technical details can be recited with regards to an embodiment of the present invention, those same technical details can be applied to other embodiments. For example, it is contemplated that an embodiment listing elements X, Y, and Z, and a second embodiment listing elements M, N, O and be combined to create a recited or non-recited embodiment X, Y, and N; or X, Y, Z, and M, etc., or any combination thereof.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method comprising:
generating an initial workflow trajectory to train a model to perform a task, the initial workflow trajectory being formed from environmental information, a prompt, and visual information;
storing sub-workflows that form the initial workflow trajectory, the sub-workflows including actions that are performed by Application Programming Interfaces (APIs);
refining the initial workflow trajectory to form an augmented workflow by iteratively optimizing the sub-workflows of the initial workflow trajectory, the iteratively optimizing includes comparing the environmental information of the augmented workflow with the environmental information from the initial workflow trajectory and selecting a sub-workflow that better meets a predetermined criteria to perform the task; and
training the model to perform the task with the augmented workflow.

2. The method of claim 1, wherein the initial workflow trajectory is generated using an instruction-final answer pair.

3. The method of claim 1, wherein iteratively comparing further comprises:
removing noise from the initial workflow trajectory by optimizing the sub-workflows with a loss function.

4. The method of claim 1, wherein iteratively comparing further comprises:
updating the environmental information based on each iteration.

5. The method of claim 1, wherein the sub-workflows correspond to tools in a tool library known by a model.

6. The method of claim 1, wherein training the model further comprises:
randomly masking one of the sub-workflows to form a randomly masked sub-workflow; and
prompting the model to predict the randomly masked sub-workflow.

7. The method of claim 6, wherein the randomly masked sub-workflows are classified as positive feedback.

8. A system for augmenting data for training a model to perform compositional visual reasoning tasks, comprising:
a processor; and
a memory storing computer-readable instructions that, when executed by the processor, cause the system to:
generate an initial workflow trajectory to train a model to perform a task, the initial workflow trajectory being formed from environmental information, a prompt, and visual information;
store sub-workflows that form the initial workflow trajectory, the sub-workflows including actions that are performed by Application Programming Interfaces (APIs);
refine the initial workflow trajectory to form an augmented workflow by iteratively optimizing the sub-workflows of the initial workflow trajectory, the iteratively optimizing includes comparing the environmental information of the augmented workflow with the environmental information from the initial workflow trajectory and selecting a sub-workflow that better meets a predetermined criteria to perform the task; and
train the model to perform the task with the augmented workflow.

9. The system of claim 8, wherein the initial workflow trajectory is generated using an instruction-final answer pair.

10. The system of claim 8, wherein the memory further causes the system to:
remove noise from the initial workflow trajectory by optimizing the sub-workflows with a loss function.

11. The system of claim 8, wherein the memory further causes the system to:
update the environmental information based on each iteration.

12. The system of claim 8, wherein the sub-workflows correspond to tools in a tool library known by a model.

13. The system of claim 8, wherein the memory further causes the system to:
randomly mask one of the sub-workflows to form a randomly masked sub-workflow; and
prompt the model to predict the randomly masked sub-workflow.

14. The system of claim 13, wherein the randomly masked sub-workflows are classified as positive feedback.

15. A computer program product comprising a non-transitory computer-readable storage medium containing computer program code, the computer program code when executed by one or more processors causes the one or more processors to perform operations, the computer program code comprising instructions to:
generate an initial workflow trajectory to train a model to perform a task, the initial workflow trajectory being formed from environmental information, a prompt, and visual information;
store sub-workflows that form the initial workflow trajectory, the sub-workflows including actions that are performed by Application Programming Interfaces (APIs);
refine the initial workflow trajectory to form an augmented workflow by iteratively optimizing the sub-workflows of the initial workflow trajectory, the iteratively optimizing includes comparing the environmental information of the augmented workflow with the environmental information from the initial workflow trajectory and selecting a sub-workflow that better meets a predetermined criteria to perform the task; and
train the model to perform the task with the augmented workflow.

16. The computer program code of claim 15, wherein the initial workflow trajectory is generated using an instruction-final answer pair.

17. The computer program code of claim 15, wherein the computer program code further includes instructions to:
remove noise from the initial workflow trajectory by optimizing the sub-workflows with a loss function.

18. The computer program code of claim 15, wherein the computer program code further includes instructions to:
update the environmental information based on each iteration.

19. The computer program code of claim 15, wherein the sub-workflows correspond to tools in a tool library known by a model.

20. The computer program code of claim 15, wherein the computer program code further includes instructions to:
randomly mask one of the sub-workflows to form a randomly masked sub-workflow; and
prompt the model to predict the randomly masked sub-workflow.
